(19) United States
(12) Patent Application Publication
(10) Pub. No.: US 2023/0056791 A1
(43) Pub. Date: Feb. 23, 2023

(54) ROBOT CLEANER

(71) Applicant: Jeongha Kim, Seoul (KR)

(72) Inventor: Jeongha Kim, Seoul (KR)

(21) Appl. No.: 17/409,237

(22) Filed: Aug. 23, 2021

(30) Foreign Application Priority Data
Aug. 19, 2021 (KR) 10-2021-0108516

(51) Int. Cl. A47L 9/28; H04N 5/235; H04N 5/265; H04N 5/76; G06K 9/00; G06K 9/20; G06K 9/46; G06K 9/62; B25J 9/16; G05D 1/02; A47L 9/30; A47L 9/00

(52) U.S. Cl. CPC A47L 9/2826; H04N 5/2351; H04N 5/2354; H04N 5/265; H04N 5/76; G06K 9/00671; G06K 9/2027; G06K 9/4661; G06K 9/6201; B25J 9/1697; G05D 1/0231; A47L 9/30; A47L 9/2852; A47L 9/2842; A47L 9/009; A47L 2201/04; A47L 2201/06

(57) ABSTRACT

A robot cleaner according to an embodiment of the present disclosure includes: a light receiving sensor configured to measure a brightness of a floor surface; an illumination part configured to irradiate the floor surface with light; a rotation device connected to the illumination part and configured to adjust a rotational angle of the illumination part; an capturing part configured to capture an image of the floor surface; a memory part that stores the image of the floor surface captured by the capturing part; a driving part including an electric motor and wheels; a vacuum suction part configured to perform a vacuum suction by being supplied with power from the electric motor; and a control part. The control part determines an operation in a capturing mode in the capturing mode and a cleaning mode when a value input from the light receiving sensor is determined to be equal to or lower than a predetermined value.

### CROSS-REFERENCE TO RELATED APPLICATION

This application claims priority to Korean Patent Application No. 10-2021-0108516 filed on Aug. 18, 2021, the entire contents of which are herein incorporated by reference.

### TECHNICAL FIELD

The present disclosure relates to a robot cleaner.

### BACKGROUND

There may be a case in which a glass of water is dropped from the table to the floor while eating at home in the bright daylight and small pieces of broken glass are scattered on the floor. Although an attempt to remove such small pieces of broken glass that have been scattered on the floor is performed, some pieces of the broken glass are too small in size and thus may not be viewed by the human eyes regardless of being in a very bright environment. As a result, the his/her foot may be injured by pieces of broken glass which has not been removed. Incidentally, he/she goes to the kitchen to drink water that night, he/she remembers breaking the glass during the day, he/she illuminates the floor using a lighting function of the mobile phone without turning on the kitchen lighting. At this time, he/she views a very small size of light may twinkle on the floor in that situation. He/she realizes that an object that exhibits such light is a piece of the glass of water which has been broken during the day. In other words, a very small size of object, such as a piece of glass, may not be viewed by the human eyes in a bright environment. However, when illumination is applied toward the object in an overall dark environment, the object may be easily sensed due to the reflection of light from the object. In addition, when the illumination of the mobile phone is applied toward the floor at various different angles, the light reflection of a piece of glass, which has not been sensed at a certain angle, may be likely sensed at angles different from the certain angle. The present inventor(s) completed the present disclosure in consideration of the above circumstances.

As the related art, there is a robot cleaner disclosed in Korean Patent Application Publication No. 10-2009-0119637 (entitled: Robot cleaner and Control Method thereof, published on Nov. 19, 2009, by LG Electronics). FIG. 1 is a flowchart for explaining a method of controlling a robot cleaner illustrated in FIG. 3 of the above related art. A method of controlling such a conventional robot cleaner includes a first control step, a second control step, a third control step, and a fourth control step. In the first control step (step S301), which is performed after the operation of the robot cleaner is started, the brightness of a floor surface is measured based on light reflected (or scattered) from the floor surface using a light receiving sensor. In a second control step (step S302), an amount of light irradiated from an illumination part provided in the robot cleaner is adjusted according to a value of the brightness of the floor surface measured by the light receiving sensor. That is, when a large amount of light is detected by the light receiving sensor, the amount of light irradiated from the illumination part is decreased to decrease the intensity of illumination. On the other hand, when a small amount of light is detected by the light receiving sensor, the amount of light irradiated from the illumination part is increased to increase the intensity of illumination. Then, in the third control step (step S303), an image of the floor surface on which the robot cleaner moves is captured. In this step, the image of the floor surface may be captured using an image sensor module and be stored in a memory. In the fourth control step (step 5304) as a subsequent step, a displacement measuring part detects a change in the captured image and measures a displacement of the robot cleaner using the detected change.

The conventional robot cleaner as described above includes the illumination part configured to illuminate the floor surface, the light receiving sensor configured to measure the brightness of the floor surface, and an image capturing/storing means configured to capture the image of the floor surface and store the same in the memory. In the conventional technology described above, the movement displacement of the robot cleaner is measured using the above-described components. On the other hand, the present disclosure uses not only the same or similar components as those in the conventional technology but also additional components which are not provided in the conventional technology, thus providing new and advantageous effects, which are hard to be achieved and predicted by the conventional technology.

### SUMMARY

An object of the present disclosure is to provide a robot cleaner capable of sensing and removing a small object having a plurality of reflective surfaces which may not be viewed by human eyes, such as a piece of broken glass, in a more efficient manner.

The present disclosure relates to a robot cleaner. The robot cleaner according to an embodiment of the present disclosure includes: a light receiving sensor configured to measure a brightness of a floor surface; an illumination part configured to irradiate the floor surface with light; a rotation device connected to the illumination part and configured to adjust a rotational angle of the illumination part; an capturing part configured to capture an image of the floor surface; a memory part that stores the image of the floor surface captured by the capturing part; a driving part including an electric motor and wheels; a vacuum suction part configured to perform a vacuum suction by being supplied with power from the electric motor; and a control part.

The control part determines an operation in a capturing mode when a value input from the light receiving sensor is determined to be equal to or lower than a predetermined value. In the capturing mode, the control part is configured to: control the driving part to move to a first position; control the illumination part, the rotation device, and the capturing part to capture the image of the floor surface multiple times while changing the rotational angle of the illumination part to which electric power is applied; and combine a plurality of images captured at the changed rotational angles and store the combined image in the memory part as a first image relating to the first position.

Subsequently, in the same manner as that performed at the first position, the control part controls the driving part to move to a second position, control the capturing part, the rotation device, and the capturing part to capture the image of the floor surface the multiple times, combine a plurality of images obtained by capturing the image of the floor surface the multiple times, and store the combined image in the memory part as a second image relating to the second position.

Further, after the capturing at a final position is completed, the control part combines all images from the first image relating to the first position to a final image obtained at the final position, and produces the combined image as a full image of the floor surface.

When the control part controls the illumination part, the rotation device, and the capturing part to capture the image of the floor surface the multiple times while changing the rotational angle of the illumination part to which the electric power is applied, the control part controls the capturing part to capture a light reflection pattern of lights reflected from an object having a plurality of reflective surfaces when the illumination part irradiates the object with the light at the changed rotational angles, and controls the memory part to store a combined image obtained by combining a plurality of images captured at the changed rotational angles.

Further, the robot cleaner according to the present disclosure may further include other additional configurations.

According to the present disclosure, it is possible to provide a robot cleaner capable of sensing and remove a small object having a plurality of reflective surfaces that may not be viewed by human eyes, such as a piece of broken glass, in a more effective manner.

### BRIEF DESCRIPTION OF THE DRAWINGS

FIG. 1 is a flowchart for explaining a method of controlling a conventional robot cleaner.

FIG. 2 is a view illustrating a robot cleaner according to an embodiment of the present disclosure.

FIG. 3 is views illustrating three different images obtained by capturing images of a floor surface using rotation illuminations located at three different rotational angles and a combined image obtained by combining the three different images according to an embodiment of the present disclosure.

FIG. 4 is a flowchart for explaining a method of controlling the robot cleaner according to an embodiment of the present disclosure.

FIG. 5 is a flowchart for explaining the method of controlling the robot cleaner in a capturing mode according to an embodiment of the present disclosure.

FIG. 6 is a view illustrating a movement route of the robot cleaner in the capturing mode according to an embodiment of the present disclosure.

FIG. 7 is a flowchart for explaining the method of controlling the robot cleaner in a cleaning mode according to an embodiment of the present disclosure.

FIG. 8 is a view illustrating a movement route of the robot cleaner in the cleaning mode according to an embodiment of the present disclosure.

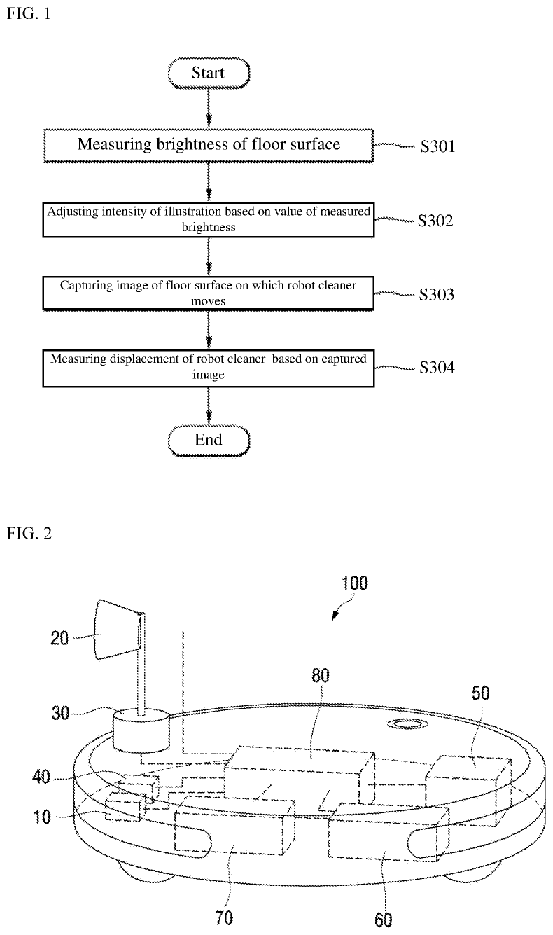

### DETAILED DESCRIPTION

The following detailed explanation of the present disclosure will be provided with reference to the accompanying drawings, which illustrate certain embodiments in which the present disclosure may be carried out as an example. These embodiments will be described in detail so that those skilled in the art can carry out the present disclosure. It should be understood that various embodiments of the present disclosure need not be mutually exclusive but not necessarily mutually exclusive. For example, certain shapes, structures, and characteristics described herein may be implemented with changes from an embodiment to other embodiments without departing from the spirit and scope of the present disclosure in connection with an embodiment. It should also be understood that the location or placement of individual components in each disclosed embodiment can be varied without departing from the spirit and scope of the present disclosure. Thus, the following detailed description is not intended to be taken as a restrictive sense, and the scope of the present disclosure is limited only by the appended claims along with all ranges which are equivalent to those claimed.

Hereinafter, various preferred embodiments of the present disclosure will be described in detail with reference to the accompanying drawings to enable those skilled in the art to easily implement the present disclosure.

### <Structure of Robot Cleaner According to Embodiment of Present Disclosure>

FIG. 2 is a view illustrating a robot cleaner according to an embodiment of the present disclosure. A robot cleaner 100 according to an embodiment of the present disclosure includes components which will be described below.

First, a light receiving sensor 10 is a component configured to measure the brightness of a floor surface. The light receiving sensor 10 measures the brightness of the floor surface and transmits the measured signal to a control part 80, which will be described later. In order to accurately measure the brightness of the floor surface, the light receiving sensor 10 is preferably mounted on a lower end portion of the robot cleaner 100, which is adjacent to the floor surface. An illumination part 20 is a component configured to irradiate the floor surface with light and be turned on or off by controlling the application of electric power based on a signal provided from the control part 80. As one of the features of the present disclosure, the illumination part 20 is attached to the robot cleaner 100 through a rotation device 30 without attached to the robot cleaner 100 at a fixed illumination angle. The rotation device 30 may change the illumination angle of the illumination part 20 with respect to the floor surface. Further, the rotation device 30 operates to rotate the illumination part 20 based on a signal provided from the control part 80. The rotational angle of the illumination part 20 by the rotation device 30 may be determined in advance. For example, the illumination angle of the illumination part 20 may be changed in a range of 45 degrees to 135 degrees. The rotation device 30 is provided to sense an object to be removed on the floor surface, which is a main target of the robot cleaner 100 according to the present disclosure. As described in the Background section of the present disclosure, the robot cleaner 100 according to the present disclosure sets, a main object to be removed on the floor surface is a small piece of glass that may not be viewed by human eyes. However, the present disclosure is not necessarily limited to the small piece of glass. The present disclosure is applicable to sense and remove a small object having a plurality of reflective surfaces, such as a piece of glass. When such a small object having a plurality of reflective surfaces, such as a piece of glass, is placed on the floor surface, if irradiation with light is performed at a fixed irradiation angle, it may be difficult to sense the small object. When the object is irradiated with light at the fixed angle, a light reflected from the object may not be directed to observer's eyes or an image sensor attached to the robot cleaner 100. This makes it difficult to sense the object. When the object having a plurality of reflective surfaces, such as a piece of glass, is irradiated with light at a plurality of changed angles, light reflected from the object is likely to be directed to the observer's eyes or the image sensor attached to the robot cleaner 100. This makes it possible to increase the possibility of sensing the object. The rotation device 30 may be implemented with, for example, a step motor. The rotation device 30 may be implemented by another means other than the step motor as long as it can rotate a shaft connected to the illumination part 20. In consideration of the configuration of the illumination part 20 which irradiates the floor surface with light at a rotational angle while being connected to the rotation device 30, the illumination part 20 may be preferably configured to irradiate the floor surface with rectilinear light. An apparatus that generates and illuminates rectilinear light has been widely known before the effective filing date of the present disclosure, and therefore, a further description of a specific configuration of an illumination part for illuminating the rectilinear light will be omitted. Although the rotation device 30 has been described to rotate the illumination part 20 in the present embodiment described with reference to FIG. 2, the present disclosure is not limited thereto. For example, the rotation device 30 may move the illumination part 20 in the vertical direction or may control the illumination part 20 in a titling manner as long as it can change the light illumination state of the light of the illumination part 20 toward the floor surface, in addition to the rotation. In addition, in FIG. 2, the rotation device 30 and the illumination part 20 connected to the rotation device 30 are illustrated to be mounted on an upper surface of the robot cleaner 100. However, this is merely a conceptual example. The structural arrangement of the illumination part 20 and the rotation device 30, which are components of the robot cleaner 100 according to the present disclosure, are not particularly limited. The illumination part 20 and the rotation device 30 may have any forms as long as they can perform the above-described functions. That is, the illumination part 20 and the rotation device 30 may be arranged anywhere on the robot cleaner 100. The capturing part 40 includes an image sensor configured to capture an image of the floor surface while the illumination part 20 irradiates the floor surface with the light. In FIG. 2, the capturing part 40 is conceptually illustrated to be located at a certain position inside the robot cleaner 100. However, since the capturing part 40 needs to capture an image of the floor surface in practice, at least a portion of the capturing part 40 may be exposed from the surface of the robot cleaner 100. Data generated by the capturing part 40 responsive to a capturing instruction from the control part 80 may be stored in the memory part 50 by the control part 80. A driving part 60 is a component that includes an electric motor and transmits a rotational power generated from the electric motor to a plurality of wheels of the robot cleaner 100 so as to move the robot cleaner 100. The transmission of the rotational power to the plurality of wheels may be controlled such that the robot cleaner 100 travels along a traveling path instructed by the control part 80. A vacuum suction part 70 is a component configured to perform a vacuum suction operation on the floor surface based on a control signal from the control part 80. In FIG. 2, dotted lines indicated between the components in FIG. 2 conceptually represent paths through which signals from sensors or control signals are transmitted.

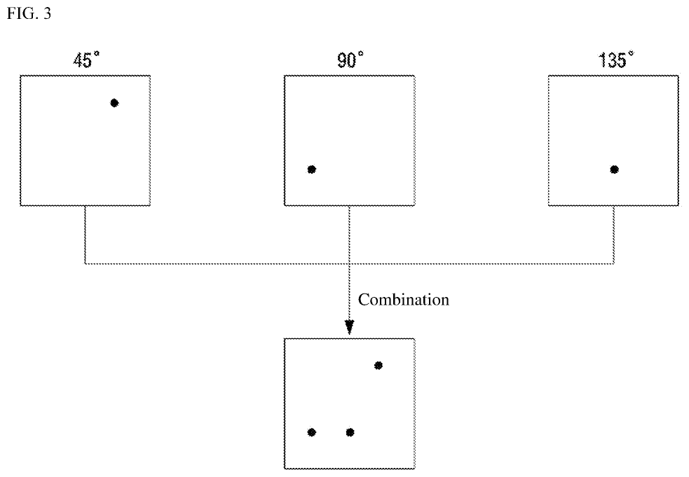

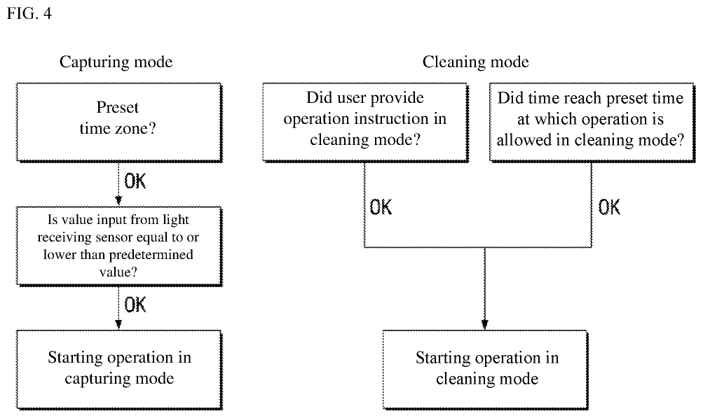

FIG. 3 is views illustrating three different images obtained by capturing images of a floor surface using rotation illuminations located at three different rotational angles and a combined image obtained by combining the three different images according to an embodiment of the present disclosure.

In an embodiment illustrated in FIG. 3, the rotation device 30 rotates the illumination part 20 at a rotational angle in a range of 45 degrees to 135 degrees, and the capturing part 40 captures an image of the floor surface at three rotational angles, for example, 45 degrees, 90 degrees, and 135 degrees. The upper left view in FIG. 3 illustrates an image of the floor surface obtained when the capturing is performed while the illumination is applied to the floor surface at the rotational angle of 45 degrees. The upper center view in FIG. 3 illustrates an image of the floor surface obtained when the capturing is performed while the illumination is applied to the floor surface at the rotational angle of 90 degrees. The upper right view in FIG. 3 illustrates an image of the floor surface obtained when the capturing is performed while the illumination is applied to the floor surface at the rotational angle of 135 degrees. The lower view in FIG. 3 illustrates an image of the floor surface obtained by combining the three images obtained at the rotational angles of 45 degrees, 90 degrees, and 135 degrees, respectively. In an embodiment of the present disclosure, an object having a plurality of reflective surfaces, such as a piece of glass, is set as a main object to be removed, and the capturing is performed multiple times while changing the rotational angle of the illumination part 20. As exemplarily and conceptually illustrated in FIG. 3, in a state in which the brightness of the floor surface is dark to a predetermined value or less, the object having a plurality of reflective surfaces reflects light in different directions with a change in illumination angle. By combining the images obtained at various illumination angles, it is possible to more precisely sense the presence of the object having a plurality of reflective surfaces placed on the floor surface.

### <Method of Controlling the Robot Cleaner According to an Embodiment of the Present Disclosure>

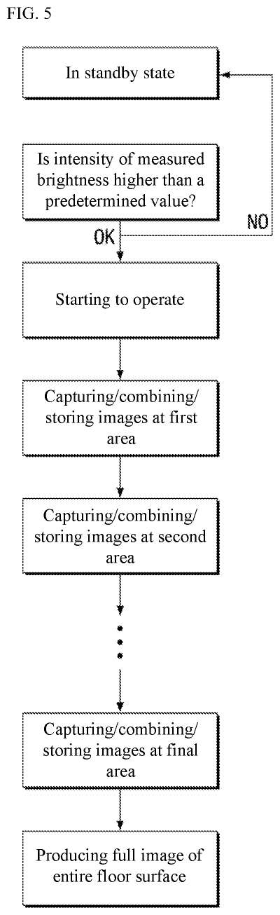

FIG. 4 is a flowchart for explaining a method of controlling a robot cleaner according to an embodiment of the present disclosure, which illustrates a starting condition for two operation modes in more details.

As illustrated in FIG. 4, the method of controlling the robot cleaner according to an embodiment of the present disclosure has two main operation modes: one is a capturing mode and the other is a cleaning mode. The capturing mode is a mode of capturing an image of the floor surface to be cleaned and sensing an object to be removed on the floor surface. The cleaning mode is a mode of performing vacuum suction on the floor based on data obtained in the capturing mode to remove the object to be removed from the floor surface. When the robot cleaner is operated in the capturing mode between the capturing mode and the cleaning mode, signal input from the light receiving sensor 10 is required to be preferentially collected. Only when a value of the input signal from the light receiving sensor 10 is a predetermined value or less, the capturing mode may be executed. The reason why the capturing mode is determined to be executed when the value of the input signal from the light receiving sensor 10 is equal to or less than the predetermined value, namely when the brightness of the floor surface is dark to the predetermined value or less, is that the main object to be removed by the robot cleaner according to the present disclosure is an object having a plurality of reflective surfaces, such as a piece of glass. In the capturing mode of sensing the object having a plurality of reflective surfaces while changing the illumination angle of the illumination part 20, when the brightness of the floor surface is high, for example, the midday sunlight shines on the floor surface, or when bright illumination is applied on the floor surface, it is difficult to sense light which is irradiated from the illumination part 20 and reflected from the small piece of glass. The operation time and the number of operations of the capturing mode may be predetermined by the user. The user may input an operation instruction to the robot cleaner 100 in advance such that the robot cleaner 100 operates in the capturing mode at a specific time zone, for example, between 1:00 AM and 2:00 AM. At a predetermined time (for example, 1:00 PM), the control part 80 of the robot cleaner 100 instructs the light receiving sensor 10 to measure the brightness of the floor surface, and when it is determined that a value of an input signal from the light receiving sensor 10 is a predetermined value or less, instructs the robot cleaner 100 to operate in the capturing mode. When it is determined that the brightness of the floor surface is equal to or greater than the predetermined value based on a value of each signal received from the light receiving sensor 10 at a predetermined time interval at the specific time zone, the capturing mode may not be executed at the specific time zone. In this case, the capturing mode may be skipped on that day. The fact that the capturing mode was skipped may be displayed on a digital display window (not illustrated) provided in the robot cleaner 100. Meanwhile, when the user provides a clean operation instruction to the robot cleaner 100, the robot cleaner 100 may operate in the cleaning mode regardless of the value of the input signal from the light receiving sensor 10. Similarly, the cleaning mode may be automatically executed at a predetermined time zone set in advance by the user. In this case, unlike the capturing mode, the collection of signals input from the light receiving sensor 10 is not performed prior to the operation in the cleaning mode.

### <Method of Controlling the Robot Cleaner in the Capturing Mode According to an Embodiment of the Present Disclosure>

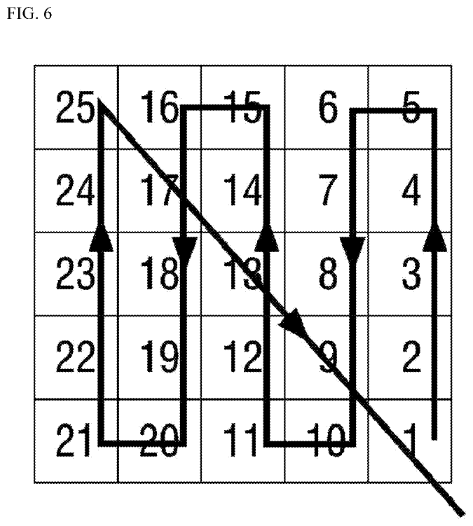

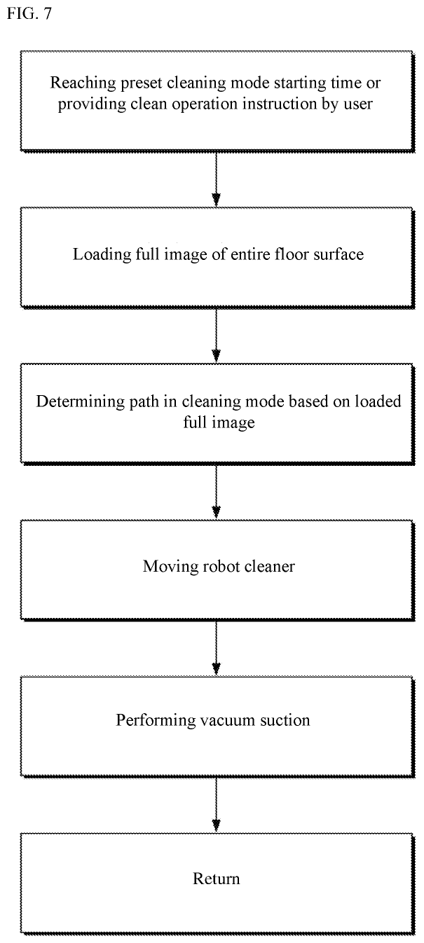

Next, a method of controlling the robot cleaner in the capturing mode according to an embodiment of the present disclosure, will be described with reference to FIGS. 5 and 6.

In an initial step, the robot cleaner 100 is in a standby state. The execution starting of the capturing mode as described above depends on the intensity of the brightness of the floor surface, which is measured by the light receiving sensor 10. When the intensity of the measured brightness is higher than a predetermined value, the robot cleaner 100 goes into the standby state again. When the intensity of the measured brightness is equal to or lower than the predetermined value, namely when light is dark, the robot cleaner 100 starts to operate in the capturing mode. As a first step during the operation in the capturing mode, the robot cleaner 100 moves to a first area along a predetermined movement route in the capturing mode (for example, a movement route as illustrated in FIG. 6, which may be changed into other various routes in advance), and captures, combines and stores images of the floor surface in the first area. As described above, the capturing is performed multiple times while changing the illumination angle of the illumination part 20 by operating the rotation device 30. The plurality of images obtained by the capturing are combined, and the combined image is stored in the memory part 50. After the combined image relating to the first area is stored in the memory part 50, the robot cleaner 100 moves a second area on the predetermined movement route, and captures, combines and stores images of the floor surface in the second area. A combined image relating to the second area is stored in the memory part 50. The aforementioned operation is performed sequentially until the final area on the predetermined movement route. Upon completing the storing of a combined image relating to the final area in the memory part 50, the robot cleaner 100 moves to the initial waiting position. During the movement or after the movement, all the combined images from the first area to the final area are combined to produce a full image of the entire floor surface, and the full image produced thus is stored in the memory part 50.

### <Method of Controlling the Robot Cleaner in the Cleaning Mode According to the Embodiment of the Present Disclosure>

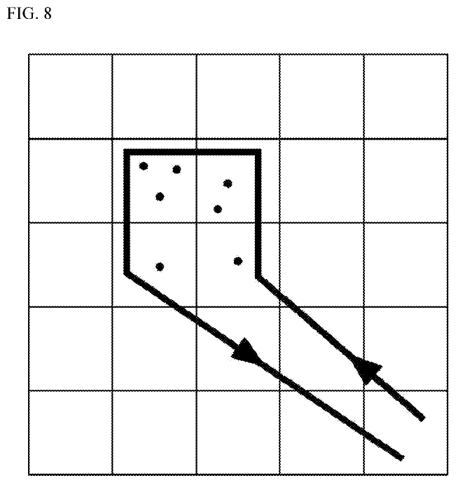

Next, a method of controlling the robot cleaner in the capturing mode according to an embodiment of the present disclosure, will be described with reference to FIGS. 7 and 8.

After the capturing mode is completed, the full image of the entire floor surface is stored in the memory part 50 as described above. Unlike the capturing mode, the operation starting in the cleaning mode is performed without the collection of signals input from the light receiving sensor 10. The cleaning mode may be automatically executed at a predetermined time zone set in advance by the user. Alternatively, the cleaning mode may be executed responsive to a clean operation instruction issued by the user even before a predetermined period of time or even if a time at which an automatic cleaning operation begins has not been set. In either case, when the cleaning mode is executed, the full image of the entire floor surface stored in the memory part 50 is loaded in a first step. As an example, the full image of the entire floor surface is as illustrated in FIG. 8. Subsequently, based on the full image of the entire floor surface, the control part 80 starts to determine a path in the cleaning mode using a previously-stored algorithm. The determination of the path is performed under consideration of the full image of the entire floor surface. For example, as illustrated in FIG. 8, when it is determined that objects to be removed are placed concentratively only in a certain area, the control part 80 may control the driving part 60 such that the robot cleaner 100 moves toward the certain area in the shortest distance. When the robot cleaner 100 reaches the target area, the control part 80 may operate the vacuum suction part 70 to perform the vacuum suction on the floor surface. The main object to be removed by the robot cleaner 100 according to the present disclosure is a small object having a plurality of reflective surfaces, such as a fragment of glass. In a case in which such small pieces of glass which has not been removed on the floor surface, the user's foot is likely to be injured by the small fragments of glass. Thus, it is desirable that the control part 80 control the vacuum suction part 70 so as to operate with a more enhanced suction force. Upon completing the vacuum suction operation determined as above, the robot cleaner 100 may return its original position.

### <Description on Jewelry Sensing Mode According to an Embodiment of the Present Disclosure>

The embodiment of the present disclosure has been described in the above with the example in which the main object to be removed is, for example, a fragment of glass, but the present disclosure is applicable to sense a state in which a jewelry is on the floor surface in an efficient manner. This will be additionally described later. A jewelry sensing mode described here is not a mode which is set separately from the above-described capturing mode. The jewelry sensing mode may be additionally executed in addition to the capturing mode when it is determined that a jewelry having a high economic value is on the floor surface during the execution of the capturing mode.

Jewelry, such as diamond, is cut to have a very large number of surfaces. There are many different methods to cut jewelry. A round cut, which is a representative diamond cutting method, cuts a diamond stone corner to have a total of 58 surfaces. Even with any cutting methods, the jewelry is generally cut to have dozens of reflective surfaces. The jewelry having such a large number of reflective surfaces exhibits a light reflective property which is clearly distinct from other objects in the capturing mode according to the present disclosure. The capturing mode according to the present disclosure is executed when the intensity of the brightness of the floor surface is equal to or lower that the predetermined value. Thus, it is possible to clearly sense the light reflected from the jewelry having a large number of reflective surfaces compared to other objects. That is, in the capturing mode according to the present disclosure, a jewelry that reflects the light irradiated from the illumination part 20 in many different directions even in a dark environment in which the brightness is equal to or lower than a predetermined level, may be clearly sensed. The capturing part 40 captures an image of the jewelry, which is produced through the light reflection in many different directions. The control part 80 determines a position at which the image is captured by the capturing part 40. This position may be stored in the control part 80 or the memory part 50. Further, at the end of the capturing mode, information about the fact that the jewelry is sensed and the position at which the image is captured by the capturing part 40 may be displayed on the digital display window provided in the robot cleaner 100 to notify the information of the user. Further, it is possible to sense the jewelry in a more reliable manner using the illumination part 20, which is one of the features of the present disclosure. When an object, which exhibits a special reflection pattern and thus is primarily presumed to be a jewelry, is sensed, the control part 80 may rotate the illumination part 20 finely around a position of the object to obtain an image for each rotation position. For example, in the case in which the illumination part 20 is rotated at three rotational angles of 45 degrees, 90 degrees, and 135 degrees around an nth area, when an object presumed to be a jewelry at the rotational angle of 90 degrees is sensed, the control part 80 may rotate the illumination part 20 again to capture an image of the object before moving to an (n+1)th area. In an embodiment, the capturing may be performed at further fine rotational angles of, for example, 85 degrees, 90 degrees, and 95 degrees. By sensing a pattern of reflected lights that changes drastically with a fine change in the illumination angle of the illumination part 20 configured to mainly perform an irradiation the rectilinear light, it is possible to more reliably determine that the object is a jewelry. When the object presumed to be a jewelry is sensed, the robot cleaner 100 may be controlled so as not to operate in the cleaning mode. As the related art, U.S. Patent Application Publication No. US2021-0089040A1 (entitled: Obstacle Recognition Method for Autonomous Robots, published by AI Incorporated) discloses a method of sensing a jewelry. The method disclosed in the above document includes comparing an image of an object captured by an image sensor with images of a very large number of template objects, including a jewelry, which are stored in an object dictionary, and determining if an object on the floor surface matches any one of the template objects stored in the object dictionary. The determination using such an image comparison requires a significant amount of computing power. In practice, in an embodiment of the technique disclosed in the above document, in order to complement a limited computing power of the robot cleaner itself, the image comparison is performed in a remote computer by utilizing a cloud computing. However, the conventional method determines if the object is a jewelry by using only the image of the object instead of the light reflective properties and comparing the image of the object with the images of the template objects. This results in a degradation of the accuracy of the jewelry identification. In the present disclosure, the illumination is applied to the object even in the dark environment, and the special reflection pattern of lights reflected from the object by the illumination the object is used to determine if the object is a jewelry. This makes it possible to identify the jewelry in a more reliable manner with a relatively small computing power.

While the capturing mode, the cleaning mode and the jewelry sensing mode have been described as the features of the present disclosure, the robot cleaner 100 according to the present disclosure may be executed even in other modes other than these modes. The robot cleaner 100 according to the present disclosure may be operated in a conventional general vacuum cleaning mode, for example, a mode in which the vacuum suction is performed along a predetermined path while avoiding obstacles. The operation mode may further include the conventional general vacuum cleaning mode in addition to the capturing mode, the cleaning mode and the jewelry sensing mode described above.

While the present disclosure has been described in the foregoing by way of embodiments and drawings which are defined with specific matters such as specific components and the like, this is only the one provided to aid in a more general understanding of the present disclosure, and the present disclosure is not limited to the above embodiments, and various modifications and variations can be made from the substrate to those skilled in the art to which the present disclosure pertains.

Accordingly, the spirit of the present disclosure should not be defined as limited to the embodiments described above, and all that have been equivalently or equivalently modified with the claims to be described below, as well as those to be within the scope of the spirit of the present disclosure.

### EXPLANATION OF REFERENCE NUMERALS

100: robot cleaner

10: light receiving sensor

20: illumination part

30: rotation device (for illumination part)

40: capturing part

50: memory part

60: driving part

70: vacuum suction part

80: control part

What is claimed is:

1. A robot cleaner, comprising:
a light receiving sensor configured to measure a brightness of a floor surface;
an illumination part configured to irradiate the floor surface with light;
a rotation device connected to the illumination part and configured to adjust a rotational angle of the illumination part;
a capturing part configured to capture an image of the floor surface;
a memory part that stores the image of the floor surface captured by the capturing part;
a driving part including an electric motor and wheels;
a vacuum suction part configured to perform a vacuum suction by being supplied with power from the electric motor; and
a control part,
wherein the control part determines an operation in a capturing mode when a value input from the light receiving sensor is determined to be equal to or lower than a predetermined value,
in the capturing mode, the control part is configured to:
control the driving part to move the robot cleaner to a first position;
control the illumination part, the rotation device, and the capturing part to capture the images of the floor surface multiple times while changing the rotational angle of the illumination part to which electric power is applied;
combine a plurality of images captured at the changed rotational angles and store the combined image in the memory part as a first image relating to the first position;
subsequently, in the same manner as that performed at the first position, control the driving part to move the robot cleaner to a second position, control the capturing part, the rotation device, and the capturing part to capture the image of the floor surface the multiple number of times, combine a plurality of images obtained by capturing the image of the floor surface the multiple number of times, and store the combined image in the memory part as a second image relating to the second position; and
after the capturing at a final position is completed, combine all images from the first image relating to the first position to a final image obtained by the capturing at the final position, and produce the combined image as a full image of the floor surface, and when the control part controls the illumination part, the rotation device, and the capturing part to capture the image of the floor surface the multiple number of times while changing the rotational angle of the illumination part to which the electric power is applied, the control part controls the capturing part to capture a light reflection pattern of lights reflected from an object having a plurality of reflective surfaces when the illumination part irradiates the object with the light at the changed rotational angles, and controls the memory part to store a combined image obtained by combining a plurality of images captured at the changed rotational angles.

2. The robot cleaner of claim 1, wherein, when the operation in a cleaning mode is instructed by a user, or at a preset operation time of the cleaning mode, the control part determines such that the robot cleaner operates in the cleaning mode,
in the cleaning mode, the control part loads the full image of the floor surface stored in the memory part, and analyzes the loaded full image to determine a movement path, and the control part controls the driving part and the vacuum suction part such that the robot cleaner moves along the determined movement path and performs the vacuum suction.

3. The robot cleaner of claim 2, wherein the control part analyzes the image of the object captured at a certain position during the operation in the capturing mode, and when the light reflection pattern of the light irradiated from the illumination part is determined to be similar to one of light reflection patterns relating to jewelries, which are previously stored in a storing part, stores information about the certain position, and displays the information about the certain position and a fact that the jewelry is sensed at an end of the capturing mode to notify them of the user.

4. The robot cleaner of claim 3, wherein, when the object sense data first area is primarily determined to be the jewelry, before controlling the driving part to move the robot cleaner to a second area, the control part controls the rotation of the illumination part by the rotation device while further changing the rotational angle of the illumination part around the rotational angle at which the object is sensed, controls the capturing part to capture an image of the object at each of the changed rotational angles, and further compares a light reflection pattern of the captured images with each of the light reflection patterns relating to jewelries, which are previously stored in the storing part.

5. The robot cleaner of claim 4, wherein, when the control part determines that the object on the floor surface is the jewelry in the capturing mode, the control part controls such that the robot cleaner does not operate in the cleaning mode even if the operation in the cleaning mode is satisfied.
